(19) United States
(12) Patent Application Publication
(10) Pub. No.: US 2026/0346924 A1
(43) Pub. Date: Nov. 5, 2026

(54) MULTI-PIECE SEALING PLUG

(71) Applicant: ILLINOIS TOOL WORKS INC., Glenview, IL (US)

(72) Inventors: Hideki Kanie, Glenview, IL (US); Ryuji Kubo, Glenview, IL (US)

(21) Appl. No.: 19/119,995

(22) PCT Filed: Oct. 16, 2023
(86) PCT No.: PCT/US2023/076986

§ 371 Date: Apr. 10, 2025

Related U.S. Application Data
(60) Provisional application No. 63/418,244, filed on Oct. 21, 2022.
(60) Provisional application No. 63/464,970, filed on May 9, 2023.

(51) Int. Cl. B62D 25/24

(52) U.S. Cl. CPC B62D 25/24

(57) ABSTRACT

A multi-piece sealing plug for sealing a panel opening in a panel. The multi-piece sealing plug includes a cap having a central portion and a lip portion and a collar protruding perpendicularly from an underside of the cap and configured to extend into the panel opening. The multi-piece sealing plug also includes an outer clip configured to engage the collar and the panel opening and a sealing lip coupled to the lip portion. In some examples, the multi-piece sealing plug includes a hot-melt ring.

### CROSS-REFERENCE

The present application claims priority to U.S. Provisional Patent Application Nos. 63/418,244, filed Oct. 21, 2022, and 63/464,970, filed May 9, 2023; each entitled “Multi-Piece Sealing Plug,” the contents of which are hereby incorporated by reference in its entirety.

### BACKGROUND

When a vehicle body of a vehicle is manufactured, multiple openings and holes are created in a panel of the vehicle body structure. For example, early in the manufacture of a motor vehicle, the body as a whole is typically subjected to phosphatation in a phosphating bath. A wash is then carried out in a cleaning bath, typically followed by a cataphoretic dip coating. For all of these processes, it is necessary that the respective liquids also enter the cavities of a body. For this purpose, the body has openings, in particular holes, which are to be subsequently closed to prevent the entry of dirt and liquids. Moreover, vehicle bodies also have holes that serve to accomplish the production process of alignment of individual body components until their integration into the overall body.

If left open, these openings and holes can allow moisture and dust to enter. Therefore, it is often necessary to use a sealing plug to seal such openings and holes to prevent dust or water from entering. The sealing plug can be inserted into the openings and holes of body parts and form a seal with the panel. A sealing plug that is easy to install and is convenient is useful to seal the openings and holes in the panel of the vehicle body structure.

Over the years, various hole plugs have been developed. For example, commonly-owed US 2015/0135598 A1 describes a rubber-elastic plug, which includes a circumferential wall and a lip formed from the former, wherein an inner, dome-like elevation is arranged on an inner circumferential surface of the wall, wherein the ceiling of the dome-like elevation is formed with ribs.

Additionally, commonly-owed US 2014/0361015A1 describes a closing plug for sealing an opening in a component. This comprises a substantially annular or cylindrical shaft, which is interrupted by ribs that are open to the outside and are hollow. Furthermore, a cone-shaped lip is provided on the shaft, wherein at least one flexible folding zone is provided on the lip, which is reversibly foldable such that, in a folded state of the folding zone, the circumference of the lip in the region of the folding zone and/or an edge of the lip is reduced.

In yet another example, a hot-melt sealing plug provides increased airtightness and strong extraction force because the hot-melt material adheres to the panel. Example hot-melt sealing plugs are further described in connection with commonly-owned U.S. Patent Publication No. 2021/0048105A1 to Xing Wang and Mengli Sun.

While effective, it can be difficult to maintain such high extraction force and adhesion in certain applications, such as when the temperature of the hot-melt sealing plug exceeds the melting temperature of the hot-melt material (e.g., over about 100 degree Celsius/212 degrees Fahrenheit) and/or in applications where a higher pressure differential exists between sides of the panel. For example, a positive pressure on one side of the sealing plug can deform and/or push the sealing plug out of the panel opening. When subject to high heat, a hot-melt sealing plug can be more easily deformed and/or pushed out of the panel opening because the hot-melt sealing plug becomes more pliable under high temperature.

Despite various advancements to date, it would nevertheless be desirable to provide a sealing plug that can be retained in a panel opening under high temperature and/or positive air pressure.

### SUMMARY

The present disclosure relates generally to a sealing plug that can be retained in a panel opening under high temperature and/or positive air pressure, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIGS. 1a and 1b illustrate a traditional clip-on sealing plug coupled to a panel and configured to plug a panel opening formed therein.

FIG. 1c illustrates a multi-piece sealing plug coupled to the panel and configured to plug the panel opening in accordance with an aspect of this disclosure.

FIGS. 2a and 2b illustrate, respectively, top and bottom isometric views of the multi-piece sealing plug.

FIGS. 2c and 2d illustrate, respectively, top and bottom top plan views of the multi-piece sealing plug.

FIGS. 2e through 2h illustrate first, second, third, and fourth side views of multi-piece sealing plug.

FIG. 2i illustrates a cross sectional view of the multi-piece sealing plug taken along cutline A-A (FIG. 2c).

FIG. 3 illustrates the multi-piece sealing plug in a dissembled arrangement.

FIGS. 4a through 4d illustrate an example process of installing the multi-piece sealing plug into the panel opening.

FIGS. 4e through 4f illustrate sealing lip design in accordance with other aspects of this disclosure.

FIGS. 5a and 5b illustrate, respectively, top and bottom isometric views of a multi-piece sealing plug in accordance with another aspect of this disclosure.

FIG. 5c illustrates a cross sectional view of the multi-piece sealing plug taken along cutline B-B (FIG. 5a).

FIGS. 6a and 6b illustrate, respectively, top and bottom isometric views of the multi-piece sealing plug in accordance with yet another aspect of this disclosure.

FIGS. 6c and 6d illustrate, respectively, top and bottom top plan views of the multi-piece sealing plug.

FIGS. 6e through 6h illustrate first, second, third, and fourth side views of multi-piece sealing plug.

FIGS. 6i and 6j illustrate, respectively, cross sectional views of the multi-piece sealing plug taken along cutline C-C (FIG. 6c) and cutline D-D (FIG. 6c).

FIGS. 7a and 7b illustrate, respectively, top and bottom isometric views of the multi-piece sealing plug in accordance with yet another aspect of this disclosure.

FIGS. 7c and 7d illustrate, respectively, top and bottom top plan views of the multi-piece sealing plug.

FIGS. 7e through 7h illustrate first, second, third, and fourth side views of multi-piece sealing plug.

FIG. 7i illustrates a cross sectional view of the multi-piece sealing plug taken along cutline E-E (FIG. 7c).

FIGS. 8a and 8b illustrate cross sectional views of the multi-piece sealing plug before and after being subjected to a high temperature.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.” Disclosed is a multi-piece sealing plug for sealing a panel opening in a panel. In one example, the multi-piece sealing plug comprises: a cap defining a central portion and a lip portion; a collar protruding perpendicularly from an underside of the cap and configured to extend into the panel opening; an outer clip configured to engage the collar and the panel opening; and a sealing lip coupled to the lip portion. In some examples, the central portion comprises one or more cross members.

In some examples, the lip portion comprises a plurality of notches distributed along a perimeter the lip portion.

In some examples, the cap and the collar are fabricated from a rigid plastic material.

In some examples, the central portion is round.

In some examples, the sealing lip is coupled to the cap via an interference fit or adhesive.

In some examples, the sealing lip is coupled to the cap via a 2k molding process.

In some examples, the sealing lip defines an outer leg that extends outwardly from a central axis of the multi-piece sealing plug.

In some examples, the sealing lip defines an inner leg that extends inwardly toward a central axis of the multi-piece sealing plug.

In some examples, the sealing lip defines an inner leg that extends inwardly toward a central axis of the multi-piece sealing plug and an outer leg that extends outwardly from the central axis of the multi-piece sealing plug.

In some examples, the outer clip is configured to surround the collar when assembled.

In some examples, the collar defines a ledge configured to engage the outer clip.

In some examples, the outer clip comprises a first feature configured to guide the outer clip during assembly, a second feature configured to engage the collar, and a third feature configured to engage the collar via the ledge.

In some examples, a hot-melt ring is configured to melt to increase the sealing effects between the sealing lip and the panel.

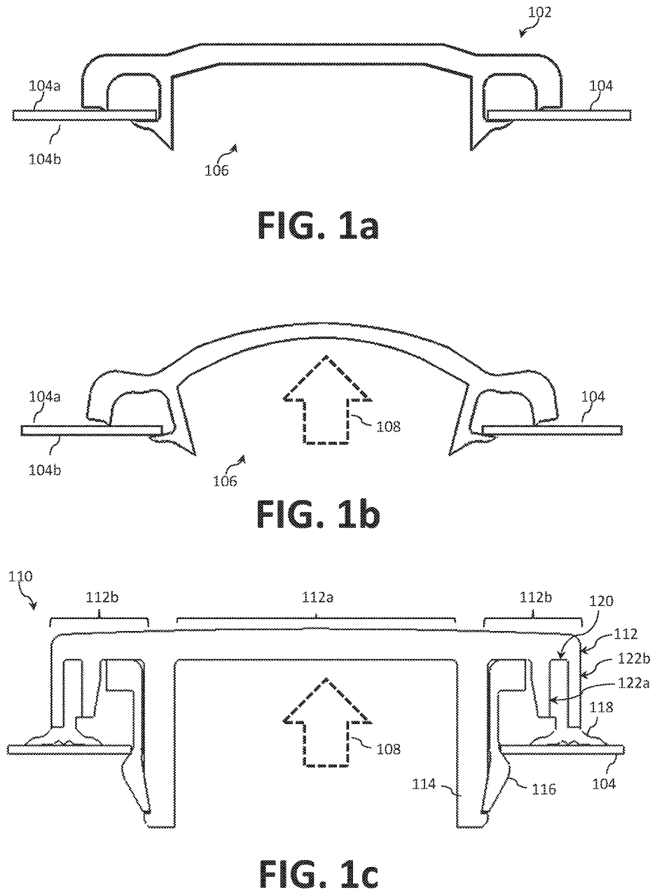

FIGS. 1a and 1b illustrate a traditional clip-on sealing plug 102 coupled to a panel 104 and configured to plug a panel opening 106 formed therein. The panel 104 may define an A-side surface 104a (e.g., a first surface) and a B-side surface 104b (e.g., a second surface, illustrated as an undersurface). The A-side surface 104a, also called a class A surface, is typically the surface that is visible after assembly and, for that reason, is more aesthetically pleasing (e.g., textured, coated, or otherwise decorated). Conversely, the B-side surface 104b, also called a class B surface, is typically the surface that is not visible after assembly and typically includes various attachment devices and/or related features. In the illustrated example, the clip-on sealing plug 102 is installed from the side of the A-side surface 104a to plug the panel opening 106. As illustrated, absent increased temperatures and/or a higher positive pressure (e.g., at the B-side surface 104b), the clip-on sealing plug 102 generally seals the panel opening 106 formed in the panel 104. When subject to increased temperatures and/or a higher positive pressure at the B-side surface 104b, which is represented by arrow 108 in FIG. 1b, the clip-on sealing plug 102 can deform and/or melt to break the seal at the panel opening 106.

When subject to increased temperatures and/or a higher positive pressure at the A-side surface 104a, the clip-on sealing plug 102 is less likely to deform sufficiently to pop out of the panel opening 106. Therefore, while the traditional clip-on sealing plug 102 could be installed from the increased temperatures and/or a higher positive pressure side (i.e., turned around), it is not always feasible to access the panel opening 106 from the increased temperatures and/or a higher positive pressure side (in this example, from the B-side surface 104b). Further, it can be beneficial to mitigate the effects of increased temperatures and/or a higher positive pressure on both sides of the panel 104.

To mitigate the effects of increased temperatures and/or a higher positive pressure, a multi-piece sealing plug 110 can be used to plug a panel opening 106 formed in a panel 104 as illustrated in FIG. 1c. As will be discussed in greater detail, the multi-piece sealing plug 110 generally comprises a cap 112, a collar 114, an outer clip 116, and a sealing lip 118. While the cap 112 can be fabricated as a single structure, the cap 112 generally defines a central portion 112a and a lip portion 112b at the perimeter of the central portion 112a. In the illustrated example, the collar 114 is generally positioned at the junction between the central portion 112a and the lip portion 112b. The collar 114 and the outer clip 116 define or otherwise include various features for attachment of the multi-piece sealing plug 110 to a panel opening 106. In use, the central portion 112a serves to block airflow, while the lip portion 112b defines or otherwise includes various features for sealing the multi-piece sealing plug 110 relative to a panel opening 106. For example, the illustrated lip portion 112b defines a seal recess 120 configured to receive and retain the sealing lip 118. The sealing lip 118 can be added and adhered or retained relative to the cap 112 via an interference fit, adhesive, and/or via a 2k molding process (e.g., double injection or 2 shot molding). In the illustrated example, the seal recess 120 is formed between an inner wall 122a and an outer wall 122b. The inner wall 122a and the outer wall 122b are generally annular and extend from the underside of the cap 112 at the lip portion 112b. As a result, the multi-piece sealing plug 110 mitigates the effects of increased temperatures and/or a higher positive pressure and, to that end, does not break the seal due to warping and/or melting. While the multi-piece sealing plug 110 is illustrated throughout this disclosure as generally circular, other shapes are contemplated (e.g., depending on the shape of the panel opening 106), including ovals, quadrilaterals (e.g., squares, rectangles), and the like.

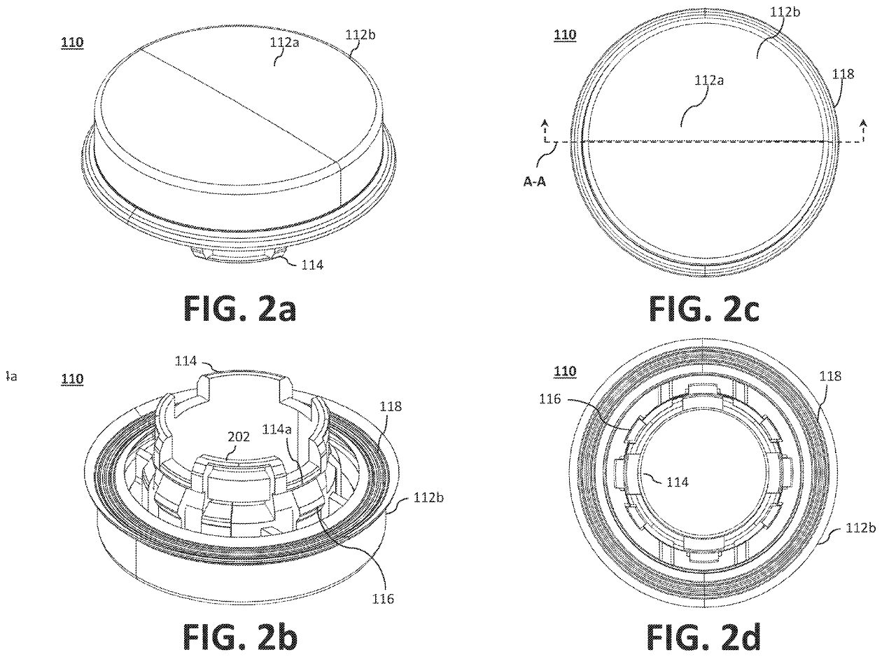

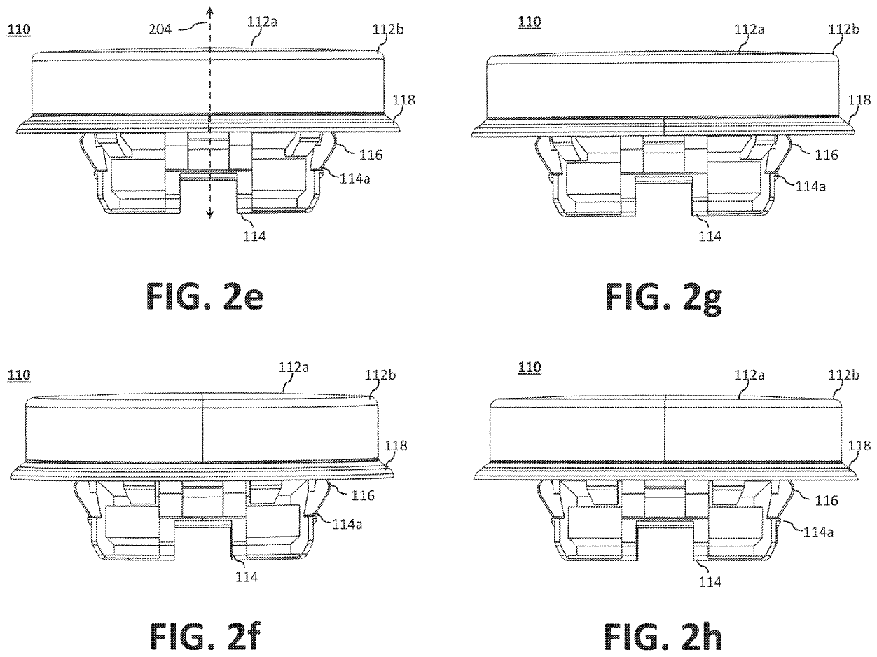

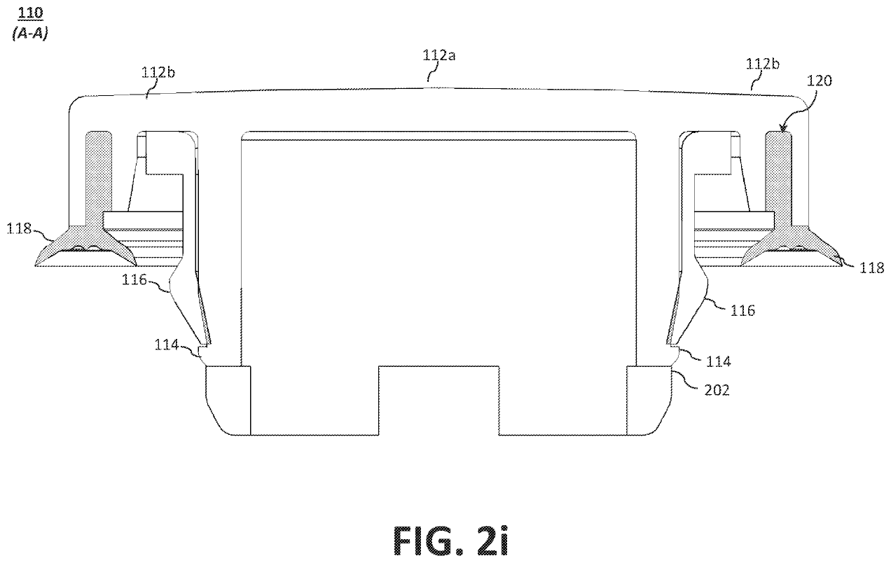

FIGS. 2a through 2i illustrate an assembled multi-piece sealing plug 110 in accordance with an aspect of this disclosure. Specifically, FIGS. 2a and 2b illustrate, respectively, top and bottom isometric views of the multi-piece sealing plug 110, while FIGS. 2c and 2d illustrate, respectively, top and bottom top plan views of the multi-piece sealing plug 110. FIGS. 2e through 2h illustrate first, second, third, and fourth side views of multi-piece sealing plug 110, while FIG. 2i illustrates a cross sectional view of the multi-piece sealing plug 110 taken along cutline A-A (FIG. 2c). While the multi-piece sealing plug 110 is illustrated as generally circular with annular component, as noted above, non-circular shapes are contemplated.

As illustrated, the multi-piece sealing plug 110 generally comprises the cap 112, the collar 114, the outer clip 116, and the sealing lip 118. The collar 114 and the outer clip 116 serve to attach the multi-piece sealing plug 110 relative to the panel opening 106. The cap 112 and the collar 114 can be formed using a rigid material. Example rigid materials include, for example, synthetic or semi-synthetic polymers (e.g., plastics, such as acrylonitrile butadiene styrene (ABS) and polyvinyl chloride (PVC), etc.), composite materials (e.g., fiber glass), or a combination thereof. In some examples, the rigid material can be PP (polypropylene) or, for example, also PBT (polybutylene terephthalate), PA (polyamide), POM (polyoxymethylene), or of a comparable material. In one example, the cap 112 and the collar 114 are formed using nylon with glass fiber. The cap 112 and the collar 114 may be formed as a unitary structure (e.g., via plastic injection molding, 3D printed thermoplastic material component, etc.). In other examples, the cap 112 and the collar 114 can be formed as separate components and joined using adhesive, welding, or the like.

The sealing lip 118 can be make from a pliable material, such as a soft plastic or rubber. In some examples, the sealing lip 118 can be made from TPV (thermoplastic rubbers) or, for example, also from TPE-S (thermoplastic elastomer based on styrenic block copolymers) or TPU (thermoplastic polyurethane), or from a comparable material. The sealing lip 118 can be fabricated separately from the cap 112 and the collar 114 via an assembly molding process. Still optionally, the sealing lip 118 may be molded separately and attached by an adhesive or in any other suitable manner to the sealing plug 110 or can be made together with the cap 112 and/or the collar 114 in a 2k overmolding process. For example, a combination of materials consisting of PP and TPV has proven to yield particularly good chemical adhesion and/or bond therebetween. In particular, in this material combination, for example, the seal recess 120 can be omitted if desired (instead relying on the chemical adhesion and/or bond therebetween.

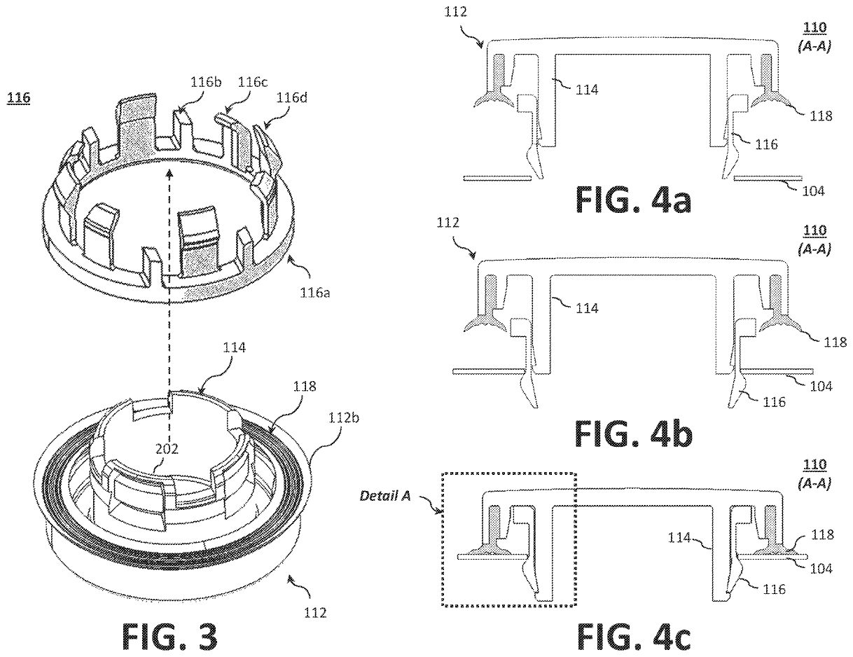

To better illustrate the structure of the sealing lip 118, the collar 114, and the outer clip 116, FIG. 3 illustrates the multi-piece sealing plug 110 in a partially dissembled arrangement. As illustrated, the collar 114 protrudes generally perpendicularly from the underside of the cap 112 and is configured to extend into the panel opening. In the illustrated example, the collar 114 is generally concentric with the cap 112 and the sealing lip 118. The collar 114 defines one or more clip features configured to engage the outer clip 116. For example, as best illustrated in FIG. 3, the collar 114 can include one or more clip features 202 configured to engage corresponding clip features formed in or on the outer clip 116.

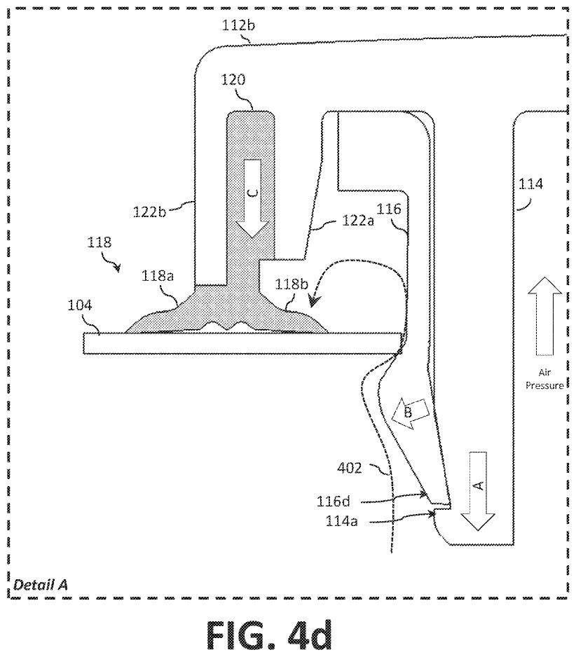

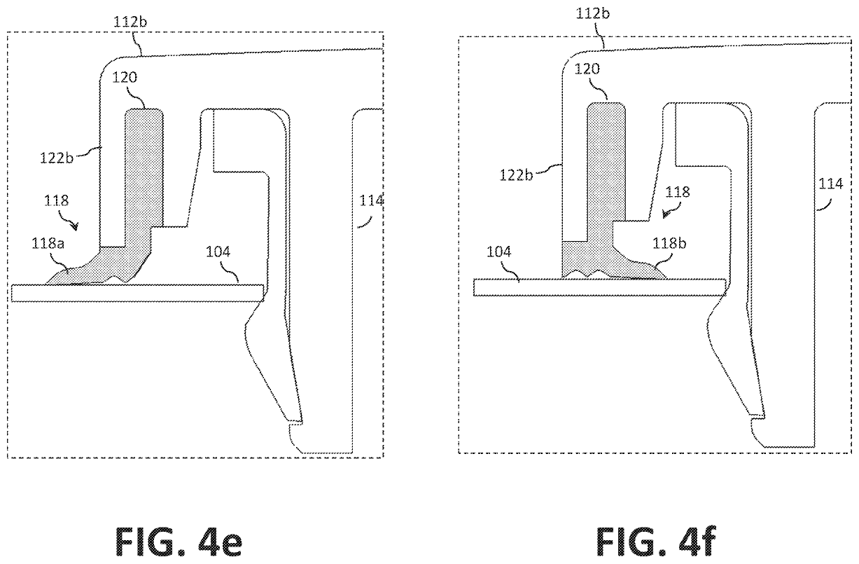

Like the cap 112 and the collar 114, the outer clip 116 can be fabricated from a rigid plastic material; however, metal can also be used where the components are formed through, for example, a stamping process. The outer clip 116 defines one or more clip features configured to engage the collar 114 and/or the panel opening 106. For example, as best illustrated in FIG. 3, the outer clip 116 can include a base 116a to which the various clip features are formed. Example clip features include, as illustrated, a first feature 116b configured to guide the outer clip 116 during assembly and/or serve as a spacer, a second feature 116c configured to engage the collar 114 (e.g., clip features 202), and a third feature 116d configured to engage the collar 114 and/or an edge of the panel opening 106. Therefore, one or more of the clip features can engage multiple surfaces. For example, when installed, the collar 114 may engage the third feature 116d to push it to toward the edge of the panel opening 106 to thereby engage the panel opening 106 (as best illustrated in FIG. 4c, discussed below).

FIGS. 4a through 4d illustrate an example process of installing the multi-piece sealing plug 110 into the panel opening 106. As illustrated in FIG. 4a, the multi-piece sealing plug 110 is pushed into the panel opening 106. The outer clip 116 initially engages the panel opening 106 as illustrated in FIG. 4b. As illustrated in FIG. 4c, further pushing the multi-piece sealing plug 110 toward the panel 104 causes the outer clip 116 to translate along (toward the cap 112) and engage one or more features of the collar 114, such as one or more ledges 114a, to engage and seal the panel opening 106. Other retention techniques include, for example, torsional and turn (twist) fastening techniques. The rigid material of the outer clip 116 resists warping and/or deformation caused by air pressure. An advantage of the installation process described herein is that the operator/assembler may install the multi-piece sealing plug 110 through a single pushing motion.

The installation process of FIGS. 4a through 4c creates various forces to better seal the panel opening as illustrated in FIG. 4d. For example, imparting a force (Arrow A) onto the collar 114 (e.g., via the cap 112) causes the features of the collar 114 to engage one or more push features (e.g., third feature 116d) outward to better engage and retain the panel opening (Arrow B). Once the third feature 116d engages the panel 104, the sealing lip 118 is pulled toward and maintained against a surface of the panel 104 (Arrow C), thereby forming a tight seal. As illustrated in FIG. 4d, which provides an enlargement of Detail A (FIG. 4c), the sealing lip 118 has a cross section that is generally Y-shaped and deforms when compressed to form a split seal. For example, the sealing lip 118 defined an outer leg 118a and an inner leg 118b—i.e. a leg on each side of the lip portion 112b. Such a configuration helps to block air pressure seepage 402 (represented as a dotted arrow) between the edge of the panel opening 106 and the outer clip 116 (or collar 114). Therefore, in some examples, the sealing lip 118 defines an inner leg 118b that extends inwardly toward a central axis 204 of the multi-piece sealing plug 110 and an outer leg 118a that extends outwardly from the central axis 204 of the multi-piece sealing plug 110.

While the sealing lip 118 of FIG. 4d is illustrated with both an outer leg 118a and an inner leg 118b extended on each side (e.g., inward and outward relative to a central axis 204), other examples are completed. FIGS. 4e through 4f illustrate sealing lip design in accordance with other aspects of this disclosure. Specifically, FIG. 4e illustrates an example sealing lip that extends outwardly and FIG. 4e illustrates an example sealing lip that extends inwardly. In these examples, the sealing lip 118 defines either an outer leg 118a that extends outwardly from the central axis 204 of the multi-piece sealing plug 110 or an inner leg 118b that extends inwardly toward the central axis 204 of the multi-piece sealing plug 110.

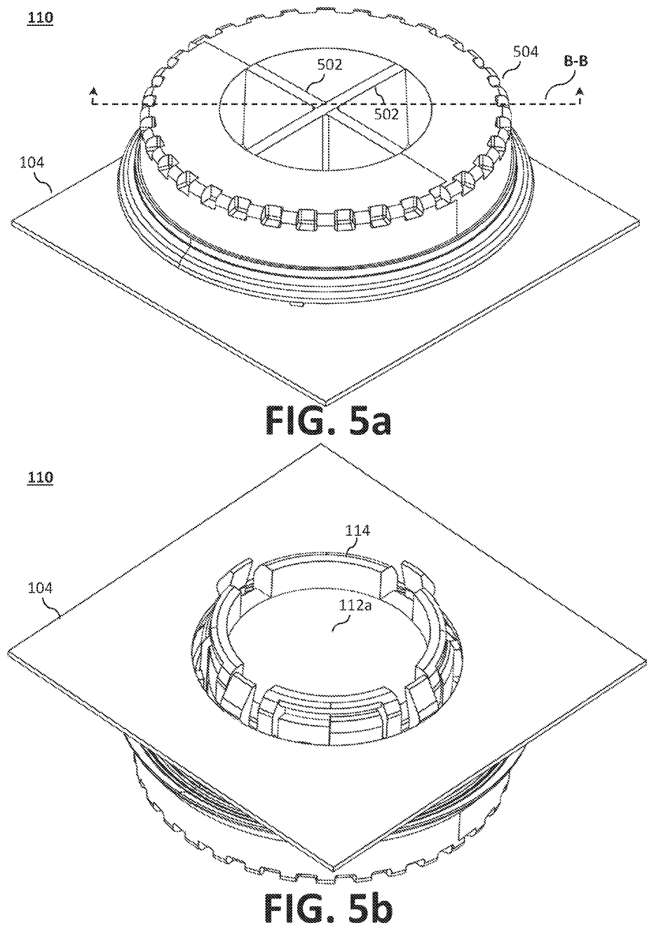

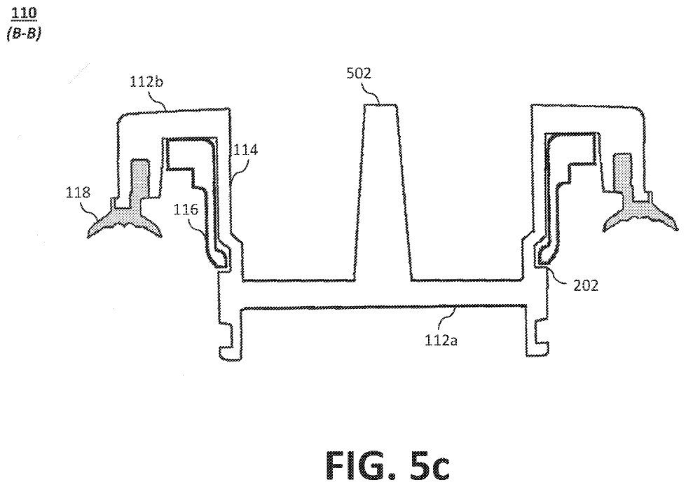

While the multi-piece sealing plug 110 is described as having a central portion 112a that is generally planar and round (e.g., a disk), additional configuration are contemplated. FIGS. 5a through 5c, for example, illustrate an assembled multi-piece sealing plug 110 in accordance with another aspect of this disclosure. Specifically, FIGS. 5a and 5b illustrate, respectively, top and bottom isometric views of the multi-piece sealing plug 110, while FIG. 5c illustrates a cross sectional view of the multi-piece sealing plug 110 taken along cutline B-B (FIG. 5a).

The multi-piece sealing plug 110 of FIGS. 5a through 5c is substantially the same as that described in connection with FIGS. 2a through 2i except that the multi-piece sealing plug 110 further comprises one or more cross members 502 and notches 504. The one or more cross members 502 provide increased rigidity to the central portion 112a to thereby handle, for example, higher pressures. In the illustrated example, the central portion 112a is still generally planar but may be positioned closer to the distal end of the collar 114 (i.e., away from the cap 112) as best illustrate in FIG. 5c to provide space to accommodate the placement one or more cross members 502. In the example illustrated in FIGS. 5a through 5c, the cross members 502 are arranged in a plus sign (+) arrangement (i.e., perpendicular to one other). In some examples, the notches 504 serve to increase rigidity at the perimeter and to increase user grip during assembly.

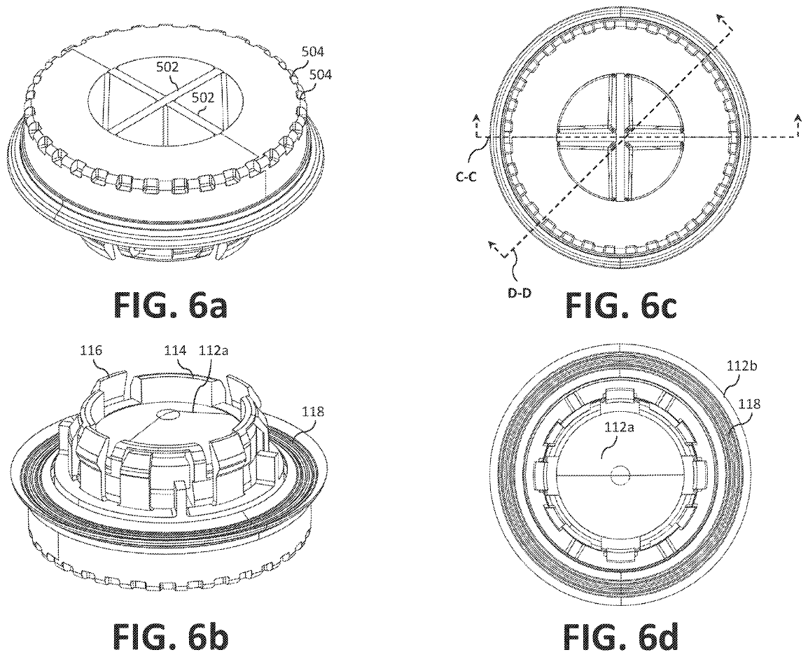

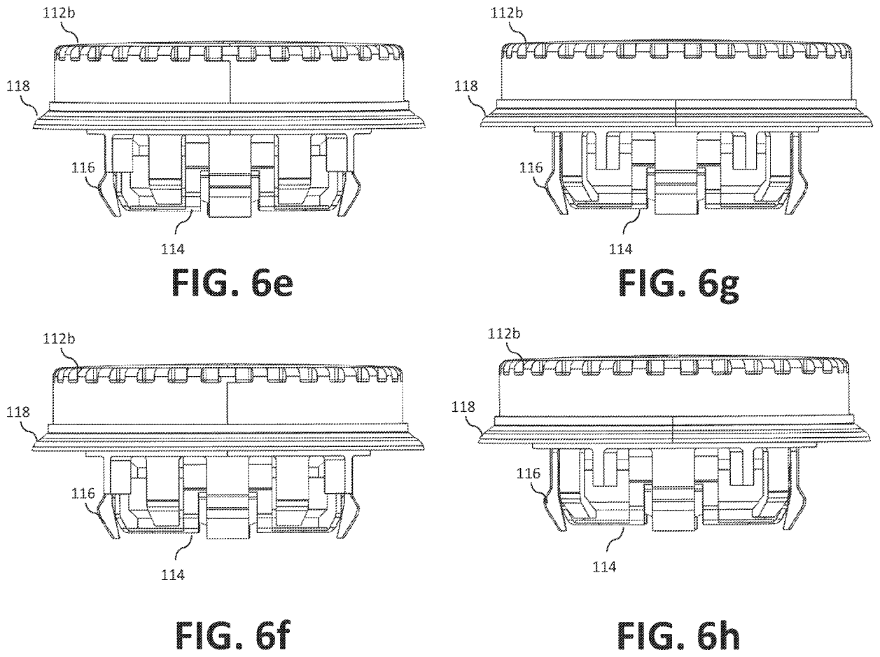

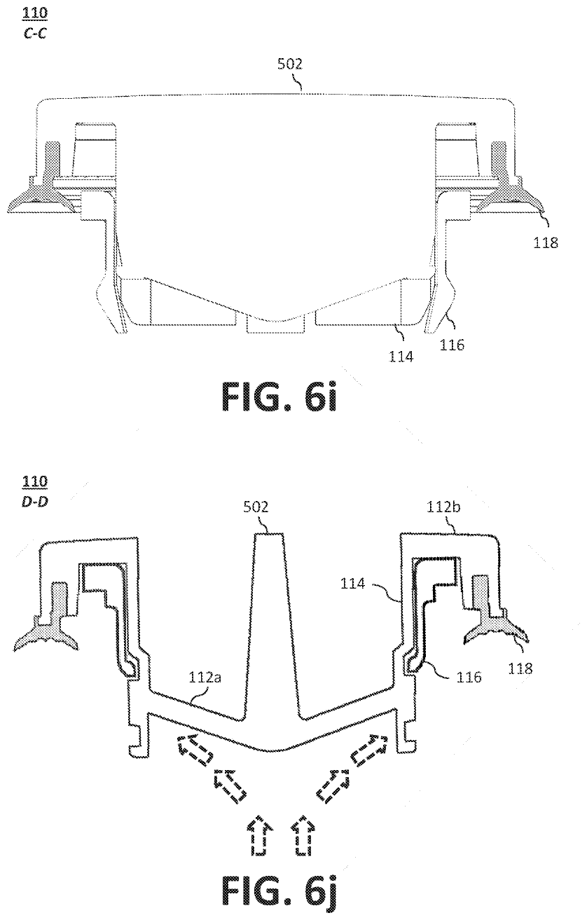

FIGS. 6a through 6j illustrate an assembled multi-piece sealing plug 110 in accordance with yet another aspect of this disclosure. Specifically, FIGS. 6a and 6b illustrate, respectively, top and bottom isometric views of the multi-piece sealing plug 110, while FIGS. 6c and 6d illustrate, respectively, top and bottom top plan views of the multi-piece sealing plug 110. FIGS. 6e through 6h illustrate first, second, third, and fourth side views of multi-piece sealing plug 110, while FIGS. 6i and 6j illustrate, respectively, cross sectional views of the multi-piece sealing plug 110 taken along cutline C-C (FIG. 6c) and cutline D-D (FIG. 6c). The multi-piece sealing plug 110 of 6a through 6j is substantially the same as that described in connection with FIGS. 5a through 5c except that the multi-piece sealing plug 110 further comprises a central portion 112a that is generally non-planar-illustrated as generally domed or conical. As best illustrated in FIG. 6j, using a central portion 112a that is non-planar mitigates the effect of higher pressure by diverting it away from the center of the multi-piece sealing plug 110. That is, in the illustrated example, the slope shape of the domed or conical central portion 112a controls direction of air to avoid pushing of the multi-piece sealing plug 110 by air pressure.

While the foregoing designs have proven to operate reliably under pressure and at 160 degrees Celsius (320 degrees Fahrenheit), in some examples, the multi-piece sealing plug 110 may need to operate under even high temperatures. For example, some applications require operation in temperatures at 200 degrees Celsius (392 degrees Fahrenheit) or more. To that end, in some examples, the multi-piece sealing plug 110 can further include a hot-melt ring to increase the plug seal strength at such high temperatures.

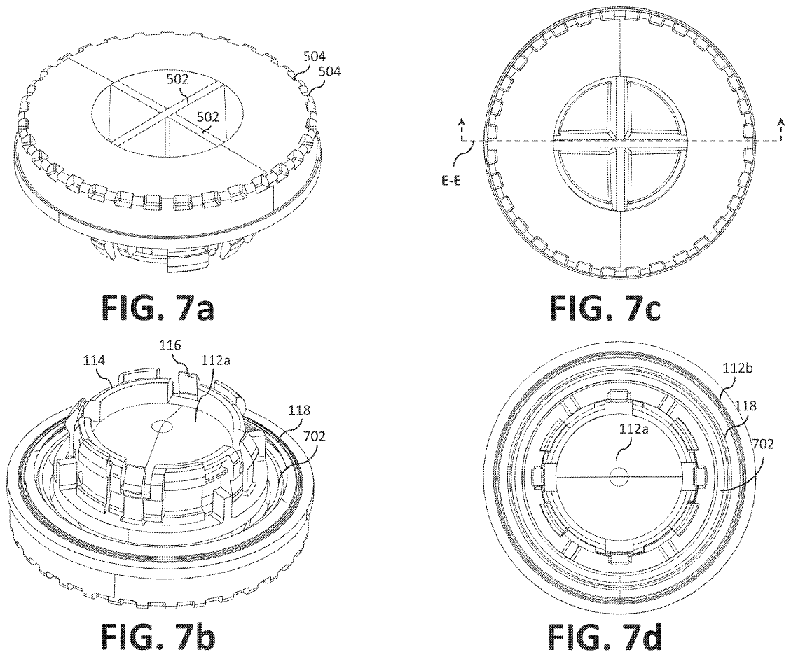

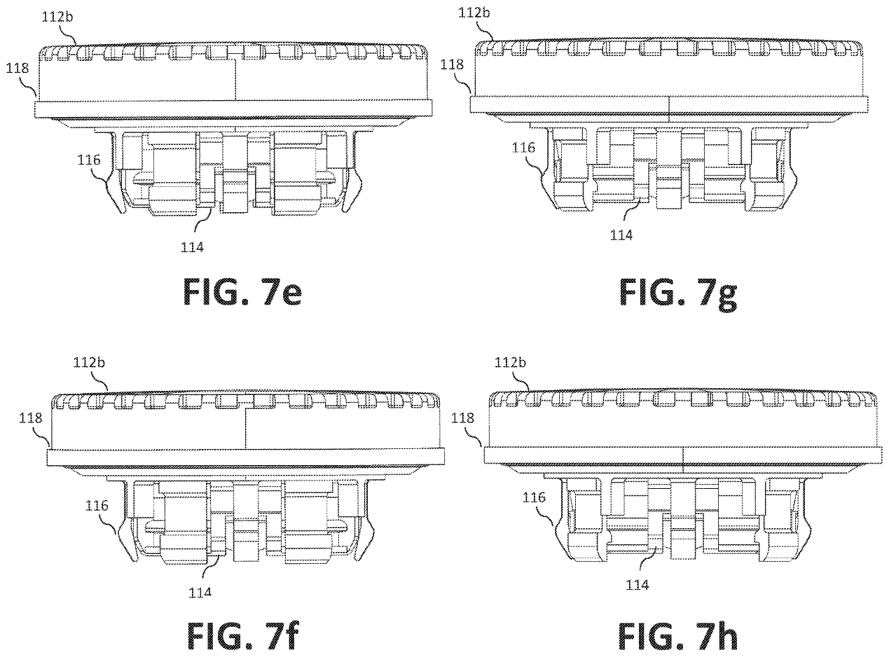

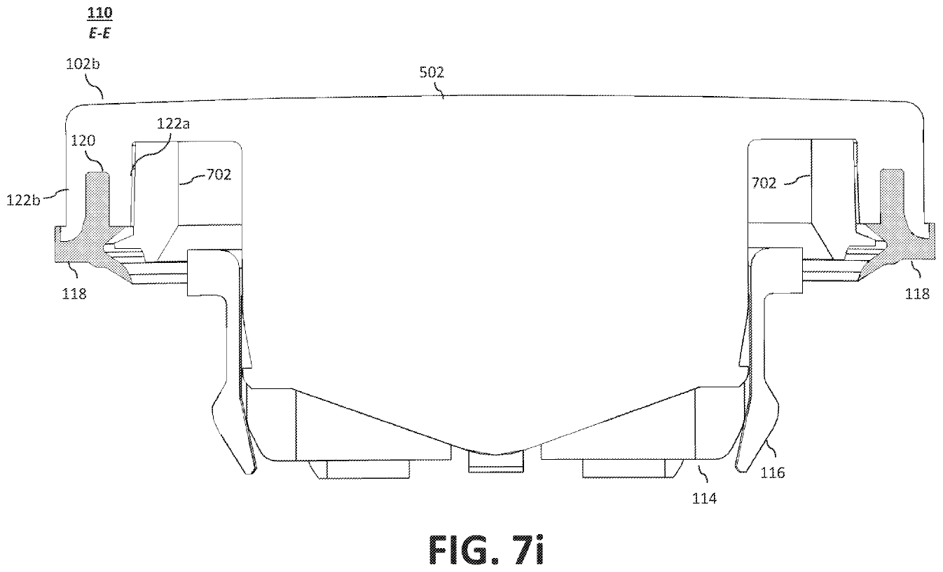

FIGS. 7a through 7i illustrate an assembled multi-piece sealing plug 110 having a hot-melt ring 702 in accordance with yet another aspect of this disclosure. Specifically, FIGS. 7a and 7b illustrate, respectively, top and bottom isometric views of the multi-piece sealing plug 110, while FIGS. 7c and 7d illustrate, respectively, top and bottom top plan views of the multi-piece sealing plug 110. FIGS. 7e through 7h illustrate first, second, third, and fourth side views of multi-piece sealing plug 110, while FIG. 7i illustrates a cross sectional view of the multi-piece sealing plug 110 taken along cutline E-E (FIG. 7c). The multi-piece sealing plug 110 of 7a through 7i is substantially the same as that described in connection with FIGS. 6a through 6j except that, as best illustrated in FIG. 7i, a cross-sectional shape of the sealing lip 118 is shaped differently and the multi-piece sealing plug 110 further comprises a hot-melt ring 702 positioned between the outer clip 116 and lip portion 112b (e.g., adjacent the inner wall 122a when installed/assembled). The hot-melt ring 702 is illustrated as generally annular ring formed from hot-melt material.

The hot-melt ring 702 can be installed, for example, by hand and positioned within the cap 112 and/or around the outer clip 116. Once installed and/or during installation (e.g., upon being subjected to higher temperatures), the hot-melt ring 702 can melt and/or soften to better conform to the adjacent components and increase the sealing effects between the components of the multi-piece sealing plug 110 and the panel 104. In some examples, the hot-melt ring 702 can be attached to the cap 112 or the outer clip 116 as a part in assembly (PIA). In some examples, the hot-melt ring 702 can be attached to the cap 112 or the outer clip 116 via an interference fit, adhesive, and/or via 2k molding (e.g., double injection or 2 shot molding). While the hot-melt ring 702 is described as being made from hot-melt material, other materials can be used instead of hot-melt, such as resins, adhesives, and/or other materials that can melt or otherwise deform to seal the connection when subjected to the temperature at a given installation location.

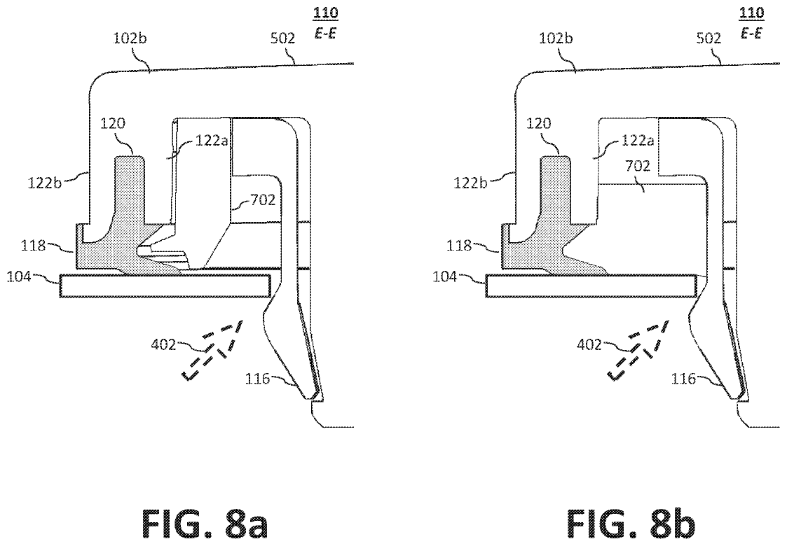

FIGS. 8a and 8b illustrate cross sectional views of the multi-piece sealing plug 110 taken along cutline E-E installed upon a panel 104 before and after being subjected to temperature sufficient to melt the hot-melt ring 702. As best illustrated in FIG. 8b, the hot-melt ring 702 melts to effectively fill the void and better conform to the adjacent components and increase the sealing effects between the components of the multi-piece sealing plug 110 and the panel 104. Any seepage of air from the positive pressure at the B-side surface, which is represented by arrow 402, can help to push the melted hot-melt ring 702 toward the lip 118 to thereby form a better seal.

The above-cited patents and patent publications are hereby incorporated by reference in their entirety. Where a definition or the usage of a term in a reference that is incorporated by reference herein is inconsistent or contrary to the definition or understanding of that term as provided herein, the meaning of the term provided herein governs and the definition of that term in the reference does not necessarily apply.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. A multi-piece sealing plug (110) for sealing a panel opening (106) in a panel (104), the multi-piece sealing plug (110) comprising:
a cap (112) defining a central portion (112a) and a lip portion (112b);
a collar (114) protruding perpendicularly from an underside of the cap (112) and configured to extend into the panel opening (106);
an outer clip (116) configured to engage the collar (114) and the panel opening (106); and
a sealing lip (118) coupled to the lip portion (112b) and configured to contact the panel (104) when assembled.

2. The multi-piece sealing plug (110) of claim 1, wherein the central portion (112a) comprises one or more cross members (502).

3. The multi-piece sealing plug (110) of claim 1, wherein the lip portion (112b) comprises a plurality of notches (504) distributed along a perimeter the lip portion (112b).

4. The multi-piece sealing plug (110) of claim 1, wherein the cap (112) and the collar (114) are fabricated from a rigid plastic material.

5. The multi-piece sealing plug (110) of claim 1, further comprising a hot-melt ring (702).

6. The multi-piece sealing plug (110) of claim 1, wherein the central portion (112a) is round.

7. The multi-piece sealing plug (110) of claim 1, wherein the sealing lip (118) is coupled to the cap (112) via an interference fit or adhesive.

8. The multi-piece sealing plug (110) of claim 1, wherein the sealing lip (118) is coupled to the cap (112) via a 2k molding process.

9. The multi-piece sealing plug (110) of claim 1, wherein the sealing lip (118) defines an outer leg (118a) that extends outwardly from a central axis (204) of the multi-piece sealing plug (110).

10. The multi-piece sealing plug (110) of claim 1, wherein the sealing lip (118) defines an inner leg (118b) that extends inwardly toward a central axis (204) of the multi-piece sealing plug (110).

11. The multi-piece sealing plug (110) of claim 1, wherein the sealing lip (118) defines an inner leg (118b) that extends inwardly toward a central axis (204) of the multi-piece sealing plug (110) and an outer leg (118a) that extends outwardly from the central axis (204) of the multi-piece sealing plug (110).

12. The multi-piece sealing plug (110) of claim 1, wherein the outer clip (116) is configured to surround the collar (114) when assembled.

13. The multi-piece sealing plug (110) of claim 1, wherein the collar (114) defines a ledge (114a) configured to engage the outer clip (116).

14. The multi-piece sealing plug (110) of claim 13, wherein the outer clip (116) comprises a first feature (116b) configured to guide the outer clip (116) during assembly, a second feature (116c) configured to engage the collar (114), and a third feature (116d) configured to engage the collar (114) via the ledge (114a).

15. The multi-piece sealing plug (110) of claim 5, wherein the hot-melt ring (702) is configured to melt to increase the sealing effects between the sealing lip (118) and the panel (104).
